(19) United States
(12) Patent Application Publication
(10) Pub. No.: US 2006/0112734 A1
(43) Pub. Date: Jun. 1, 2006

(54) Modified chemical vapor deposition device for manufacturing optical fiber preform

(76) Inventors: Jae-Sun Kim, Seoul (KR); Ji-Sang Park, Seoul (KR); Lae-Hyuk Park, Seoul (KR)

Correspondence Address: JONES DAY, 222 EAST 41ST ST, NEW YORK, NY, 10017, US

(21) Appl. No.: 10/541,742

(22) PCT Filed: Dec. 5, 2003
(86) PCT No.: PCT/KR03/02668

§ 371 Date: Jul. 6, 2005

(51) Int. Cl. C03B 37/07

(52) U.S. Cl. 65/489; 65/494; 65/530

(57) ABSTRACT

A modified chemical vapor deposition (MCVD) device for making an optical fiber preform is disclosed. The MCVD device includes a quartz tube and its junctions, a bubbler system for generating reaction gas to be supplied to the quartz tube, and a rotary connector for interfacing the bubbler system to a main shaft of the lathe supporting the quartz tube. The device isolates the quartz tube and its junctions, the bubbler system and the rotary connector from external atmosphere to keep the isolated area to be under the inert gas condition, thereby preventing moisture or hydrogen components from penetrating into the quarts tube from the external atmosphere.

### TECHNICAL FIELD

The present invention relates to manufacture of an optical fiber, and more particularly to a device for preventing moisture or hydrogen from being penetrated into a quartz tube while an optical fiber preform is manufactured using MCVD (Modified Chemical Vapor Deposition).

### BACKGROUND ART

FIG. 1 shows a conventional MCVD device for manufacturing an optical fiber preform.

While a high-purity quartz tube 1 is fixed to a lathe, a mixed reaction gas such as SiCl₄, GeCl₄ or O₂ generated in a bubbler system 5 is supplied into the quartz tube 1 through a gas inlet 2. At this time, the quartz tube 1 is uniformly rotated and its outside is heated by an oxygen-hydrogen burner. The reaction gas flowed into the quartz tube 1 forms a silica deposition layer on an inner wall of the quartz tube 1 by the following reaction formulas 1 and 2.
SiCl₄+O₂→SiO₂+2Cl₂ Reaction Formula 1
GeCl₄+O₂→GeO₂+2Cl₂ Reaction Formula 2

However, the aforementioned conventional MCVD is likely to combine hydroxyl groups in the silica deposition layer due to the following factors.

First, the mixed reaction gas supplied into the quartz tube contains a slight amount of moisture, hydrogen components and other transition metal impurities.

Second, a rotary connector 4, gas inlet and outlet 2 and 3 and the bubbler system 5 of the MCVD device are main routes through which moisture is introduced, so moisture or hydrogen components may be flowed through the routes.

As mentioned above, the moisture or hydrogen components introduced into the quartz tube generate complicated chemical reactions as seen in the following reaction formulas 3 and 4.
aSiCl₄+bSiHCl₃+cH₂O+dH₂eSiO₂+fSiOH+gHCl+hCl₂ Reaction Formula 3
aGeCl₄+bGeHCl₃+cH₂O+dH₂eGeO₂+fGeOH+gHCl+hCl₂ Reaction Formula 4

These reactions reduce deposition efficiency and form hydroxyl groups due to the presence of the reacted materials in the silica structure. And the formed hydroxyl groups increase an absorption loss at 1383 nm. “Partition of hydrogen in the modified chemical vapor deposition process, J. Am. Ceram. Soc, vol 64, p325-327” and “Incorporation of OH in glass in the MCVD process, J. Am. Ceram. Soc., vol 62, p638-640” have reported a mechanism that moisture and hydrogen components contained in reaction chemical or reaction gas participates in the deposition reaction to form hydroxyl groups. According to the reports, as the amount of moisture and hydrogen components increases in the reaction chemical, the amount of hydroxyl groups (OH) contained into the deposition layer is also increased.

In order to prevent hydroxyl groups from being combined to the deposition layer in the quartz tube, there is proposed an MCVD which additionally performs a dehydration process as seen in the following reaction formula 5 by introducing dehydration gas such as Cl₂ into the quartz tube together with the mixed reaction gas.
H₂O+Cl₂ [symbol] 2HCl+½O₂ Reaction Formula 5

However, the MCVD is not easy to adopt the dehydration process during its procedure since the deposition and sintering processes are conducted at once, differently from OVD (Outside Vapor Deposition) and VAD (Vapor Axial Deposition).

In addition, in addition to the moisture and hydrogen components contained in the mixed reaction gas, moisture is apt to be flowed in through a rotating body, a tube junction or an exhaust line of the MCVD device.

Such penetration of moisture or hydrogen components is particularly serious in a portion connected to the rotary connector 4. FIG. 2 shows the rotary connector 4 and its surrounding parts in the conventional MCVD device.

The rotary connector 4 is a connector between a transfer line of reaction chemical and gas and a rotating body acting for rotation of the tube. The rotary connector 4 connects a headstock 7 at which the rotating body of the lathe is positioned, to a reaction gas input pipe 8 through which the reaction chemical is introduced. The rotary connector 4 is also connected to a purging line 9. This rotary connector 4 is hardly isolated from the external atmosphere since it is a connection part of a rotating unit and a fixed unit. In addition, moisture and impurities in the external atmosphere may be most easily introduced through the rotary connector 4 because of abrasion and deformation of the connecting parts due to friction when it is used for a long time. Thus, it is very important to prevent moisture and other impurities in the external atmosphere from being flowed in through such connecting parts in order to manufacture a low-loss optical fiber.

### DISCLOSURE OF INVENTION

In order to manufacture an OH-free optical fiber having low losses for the entire wavelength range, it is required to control moisture or other impurities not to be flowed into the reaction area from the external atmosphere during the MCVD procedure. For this purpose, the inventors propose an MCVD device which is capable of keeping an inert gas atmosphere such as N₂, He and Ar by isolating parts (e.g., a rotating body, a tube junction, an exhaust part, a bubbler system and so on), which are apt to allow penetration of moisture and hydrogen components, from the external atmosphere.

However, in case of the bubbler system, it is very difficult to completely seal a combined portion between the bubbler and the pipe. Thus, the inventors additionally propose a method for eliminating moisture in the reaction chemical by installing an ultraviolet lamp or a laser generator in the bubbler system.

The reaction for eliminating moisture in the reaction chemical with the use of an ultraviolet ray of 150 to 400 nm is already reported in “Optical fiber communication, volume 1: Fiber fabrication, academic press, p16-17”.

The above document introduces a photochemical reaction as follows.
hv
Cl₂→2Cl
2Cl₂+H₂O→2HCl+½O₂ Reaction Formula 6

According to the first aspect of the invention, there is provided a MCVD device for manufacturing an optical fiber preform, which includes a quartz tube; a lathe for supporting the quartz tube so that the quartz is rotatable on a central axis thereof; a bubbler system for generating reaction gas to be supplied into the quartz tube; a rotary connector for interfacing a main headstock of the lathe with the bubbler system; and a sealing chamber surrounding an area including the rotary connector in order to isolate the area including the rotary connector from the external atmosphere, wherein the sealing chamber includes an input pipe for flowing inert gas therein and an output pipe for discharging the inert gas, whereby the inside of the sealing chamber is kept in an inert gas atmosphere.

According to the second aspect of the invention, there is also provided a MCVD device for manufacturing an optical fiber preform, which includes a quartz tube; a lathe for supporting the quartz tube so that the quartz is rotatable on a central axis thereof; a bubbler system for generating reaction gas to be supplied into the quartz tube; a rotary connector for interfacing a main headstock of the lathe with the bubbler system; a sealing chamber surrounding an area including the rotary connector in order to isolate the area including the rotary connector from the external atmosphere; and a cabinet for isolating an area including at least the quartz tube and its junctions from the external atmosphere and keeping the isolated area in an inert gas atmosphere, wherein the sealing chamber includes an input pipe for flowing inert gas therein and an output pipe for discharging the inert gas, whereby the inside of the sealing chamber is kept in an inert gas atmosphere.

According to the third aspect of the invention, there is also provided a MCVD device for manufacturing an optical fiber preform, which includes a quartz tube; a lathe for supporting the quartz tube so that the quartz is rotatable on a central axis thereof; and a bubbler system for generating reaction gas to be supplied into the quartz tube, wherein the bubbler system includes at least one bubbler for generating reaction gas to be supplied to the quartz tube; a mass flow controller for controlling a flow rate of the reaction gas supplied from the bubbler; a bubbler cabinet for isolating the bubbler and the mass flow controller from the external atmosphere, and keeping the isolated area in an inert gas atmosphere; and a light emission source positioned in the bubbler cabinet to emit ultraviolet rays or laser having a wavelength of 400 nm or below.

According to the fourth aspect of the invention, there is also provided a MCVD device for manufacturing an optical fiber preform, which includes a quartz tube; a lathe for supporting the quartz tube so that the quartz is rotatable on a central axis thereof; a bubbler system for generating reaction gas to be supplied into the quartz tube; a first cabinet for isolating at least the quartz tube and its junctions from the external atmosphere so that the isolated area is kept in an inert gas atmosphere; a second cabinet for isolating the bubbler system from the external atmosphere so that the isolated area is kept in an inert gas atmosphere; and a light emission source positioned in the second cabinet to emit ultraviolet rays or laser having a wavelength of 400 nm or below.

According to the fifth aspect of the invention, there is also provided a MCVD device for manufacturing an optical fiber preform, which includes a quartz tube; a lathe for supporting the quartz tube so that the quartz is rotatable on a central axis thereof; a bubbler system for generating reaction gas to be supplied into the quartz tube; a rotary connector for interfacing a main headstock of the lathe with the bubbler system; a sealing chamber surrounding an area including the rotary connector in order to isolate the area including the rotary connector from the external atmosphere; a first cabinet for isolating at least the quartz tube and its junctions from the external atmosphere so that the isolated area is kept in an inert gas atmosphere; a second cabinet for isolating the bubbler system from the external atmosphere so that the isolated area is kept in an inert gas atmosphere; and a light emission source positioned in the second cabinet to emit ultraviolet rays or laser having a wavelength of 400 nm or below, wherein the sealing chamber includes an input pipe for flowing inert gas therein and an output pipe for discharging the inert gas, whereby the inside of the sealing chamber is kept in an inert gas atmosphere.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 is a schematic view showing an MCVD device according to the prior art;

FIG. 2 is a schematic view showing a rotary connector and relevant parts in the MCVD device of FIG. 1;

FIG. 3 is a schematic view showing a device for manufacturing an optical fiber preform according to the present invention;

FIG. 4 is a schematic view showing a rotary connector and relevant parts in the device of FIG. 3;

FIG. 5 is an enlarged view showing a bubbler system shown in FIG. 3; and

FIG. 6 is a graph showing a wavelength loss of the optical fiber manufactured using the present invention.

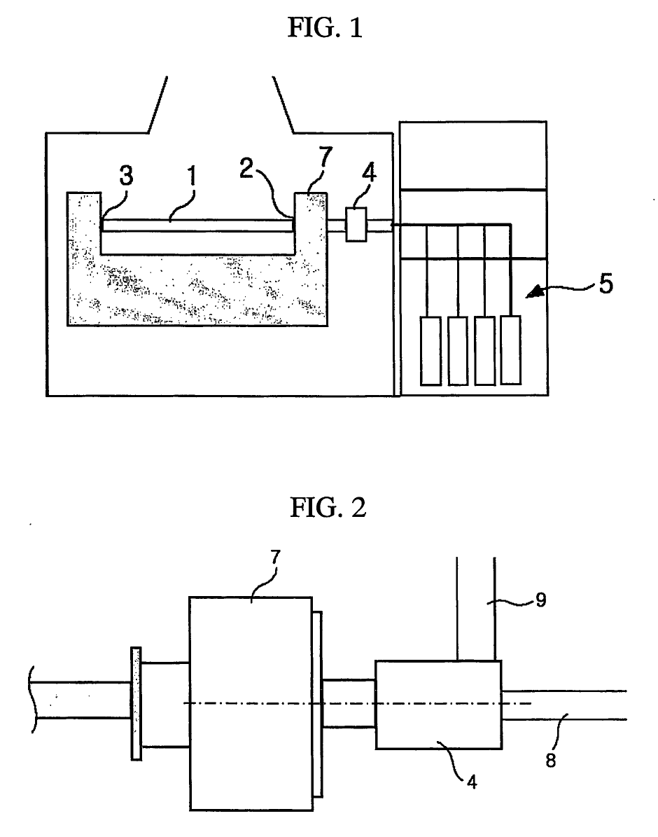

### BEST MODES FOR CARRYING OUT THE INVENTION

Hereinafter, preferred embodiments of the present invention will be described in detail with reference to the accompanying drawings.

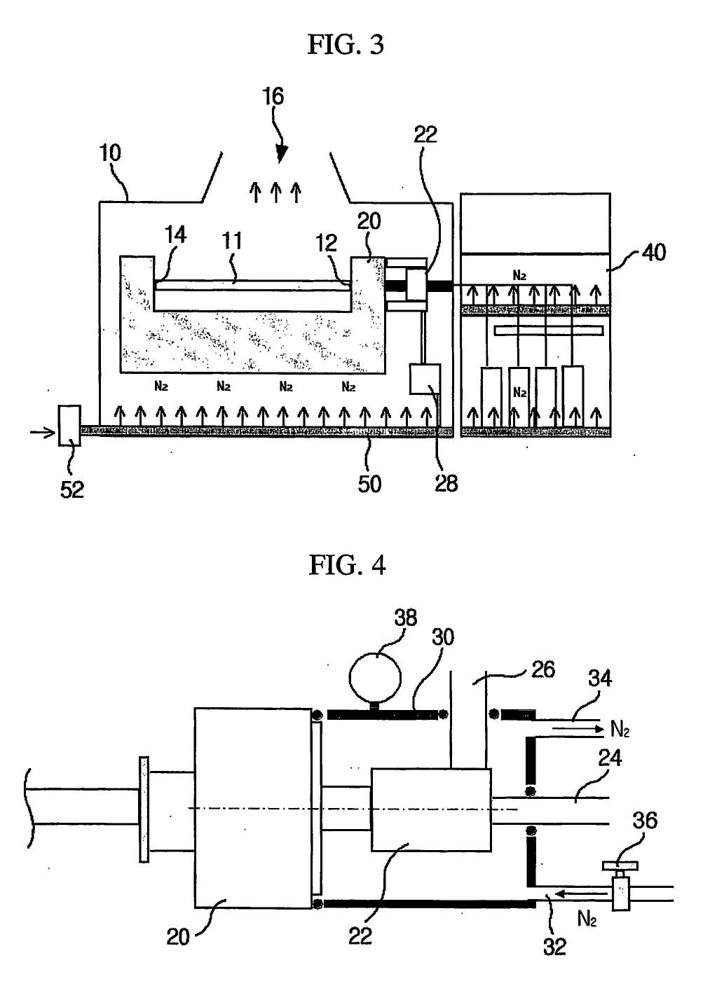

FIG. 3 shows an MCVD (Modified Chemical Vapor Deposition) device for manufacturing an optical fiber preform according to an embodiment of the present invention.

The MCVD device shown in FIG. 3 is kept in an inert gas atmosphere in which at least one of a rotating body, various junctions and a bubbler system is isolated from the external atmosphere.

Referring to FIG. 3, a quartz tube 11 mounted to the lathe is isolated from the external atmosphere by means of a cabinet 10. At this time, a headstock 20 is installed on the lathe, and the quartz tube 11 is installed to the headstock 20. The quartz tube 11 has a reaction gas inlet hole 12 and a gas discharge hole 14 at its both ends. In addition, a rotary connector 22 is installed to the headstock 20 in connection with the quartz tube 11, and the rotary connector 22 is connected to a bubbler system 40.

The air in the cabinet 10 is kept in the inert gas atmosphere so that concentration of moisture or hydrogen components may be controlled in the range of several ppm to several thousand ppm. In this reason, an inert gas torch 50 having many nitrogen inject holes is mounted at a predetermined position of the lower portion of the cabinet 10. This inert gas torch 50 preferably has parallel multi inject holes so that the entire space in the cabinet 10 may be kept in the inert gas atmosphere. In addition, a discharge hole 16 is formed on the top of the cabinet 10 so that the inert gas may form a certain flow in the cabinet 10.

The nitrogen gas supplied to the inert gas torch 50 pass through a gas purifier 52, which makes a moisture content in the inert gas be kept constantly. At this time, the nitrogen gas purified by the gas purifier 52 preferably has a moisture content less than 100 ppm.

As mentioned above, by isolating the whole lathe having the quartz tube from the external atmosphere and keeping the isolated space in an inert gas atmosphere, it is possible to prevent moisture or hydrogen components from being penetrated into a reaction region through a junction between the gas discharge hole 14 and the quartz tube 11 or a junction between the gas inlet hole 12 and the quartz tube 11.

FIG. 4 is an enlarged view showing a rotating body including the rotary connector, in the MCVD device of FIG. 3. This rotating body includes the rotary connector 22 for connecting the headstock 20 of the lathe for supporting the quartz tube to the reaction gas input pipe 24 through which the reaction chemical is flowed to the quartz tube. The rotary connector 22 is connected to a purging line 26.

In the present embodiment, in order to prevent moisture or hydrogen components from being penetrated from the external atmosphere through the junctions of the rotary connector 22, the rotary connector 22 and its junctions are isolated from the external atmosphere and kept in the inert gas atmosphere.

In other words, a sealing chamber 30 surrounds the region including the rotary connector 22 and its junctions, and the area in the sealing chamber 30 is kept in the inert gas atmosphere using such as nitrogen gas. For this purpose, the sealing chamber 30 is provided with an inert gas input pipe 32 for inputting inert gas into the sealing chamber 30 and an output pipe 34 for discharging inert gas out of the sealing chamber 30.

In addition, a controller 36 is installed to the inert gas input pipe 32 to control pressure in the sealing chamber 30. This controller may be a regulator or a needle value for controlling an amount of the supplied gas.

The sealing chamber 30 is made of metal material such as aluminum, SUS, tartar and copper, or plastic material such as acryl.

In addition, the inert gas supplied into the sealing chamber 30 may be purified once more with the use of a gas purifier 28 (see FIG. 3). This gas purifier 28 makes moisture in the supplied inert gas be kept below 10 ppm.

The sealing chamber 30 may also be provided with a pressure gauge 38 which makes it possible to measure pressure in the sealing chamber 30.

The sealing chamber 30 configured as above is fixed to the headstock 20 of the lathe for supporting the quartz tube so that the sealing chamber 30 is not movable. If the sealing chamber 30 is movable, this movement may affect on the internal pressure of the tube since the pressure around the rotary connector 22 becomes irregular. In addition, an excessive pressure as well as the irregular pressure may affect on the internal pressure of the quartz tube in the deposition and sintering processes, the pressure in the sealing chamber 30 is set in the range of 0.5 to 1.5 atm, preferably not more than 10% over the external atmosphere.

It becomes possible to more reliably prevent moisture or hydrogen components from being penetrated into the quartz tube from the external atmosphere by housing the whole lathe with a cabinet as shown in FIG. 3 and isolating the rotating body including the rotary connector as shown in FIG. 4. Thus, the formation of hydroxyl groups in the deposition layer is repressed, so it is possible to manufacture an optical fiber having a less loss together with reproducibility of the product.

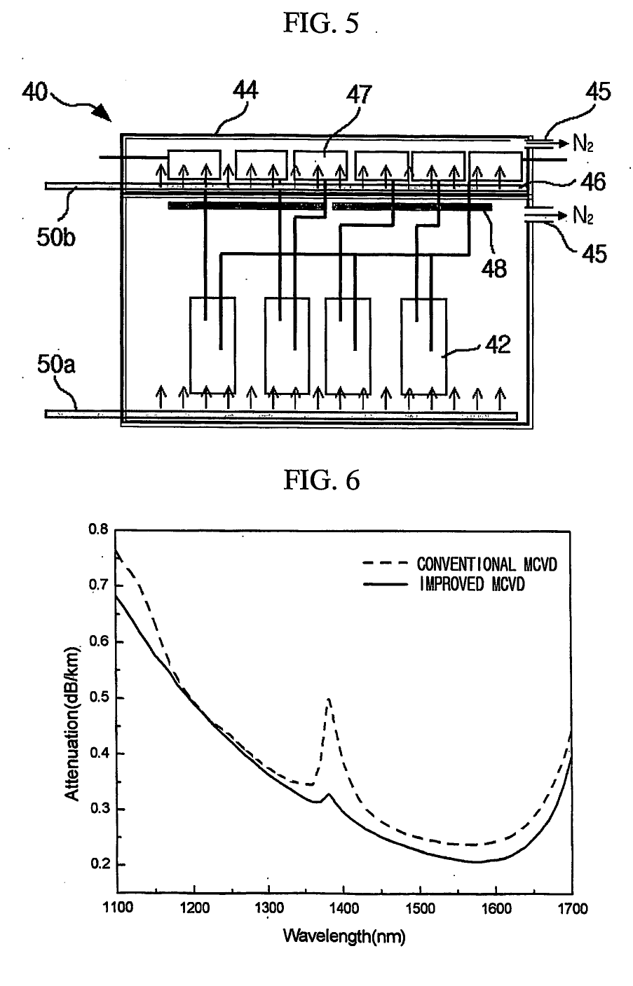

FIG. 5 shows the bubbler system 40 according to the present invention. The bubbler system 40 is configured so that bubblers 42 are positioned in a bubbler cabinet 44 made of iron. A mass flow controller (MFC) 47 is positioned at the top of the bubbler 42 for controlling flow rates of the reaction chemical and the gas. This MFC 47 is also installed inside the bubbler cabinet 44 for isolation from the external atmosphere.

Generally, the bubbler 42 made of quartz uses SUS pipes and Teflon for connections. However, since these connections are not completely sealed, moisture or other impurities may be introduced through the connections from the external atmosphere. Thus, it is important to prevent contamination of the reaction chemical by preventing leakage in the connections.

For this purpose, in the present embodiment, the bubbler cabinet 44 surrounds the region including the bubblers 42 to be isolated from the external atmosphere, and keeps the inside of the bubbler cabinet 44 in a nitrogen atmosphere. In order to supply nitrogen gas into the bubbler cabinet 44, at least one inert gas torch 50a or 50b is installed to the bubbler cabinet 44 as shown in FIG. 5. The inert gas torches 50a and 50b preferably adopt one substantially identical to the inert gas torch 50 of FIG. 3, for example having parallel multi inject holes.

An inert gas discharge hole 45 is formed in the bubbler cabinet 44 so that inert gas such as N₂, He and Ar may be regularly flowed in the bubbler system 40.

In addition, the bubbler system 40 of this embodiment may be additionally provided with an ultraviolet lamp 48 for purifying the reaction chemical. This ultraviolet lamp 48 preferably adopts an ultraviolet light source having a wavelength less than 400 nm, more preferably in the range of 150 to 400 nm. In other cases, it is also possible to use a laser generator instead of the ultraviolet lamp 48.

The ultraviolet ray or laser emitted from the ultraviolet lamp or the laser generator preferably plays a unique role of eliminating moisture, hydroxyl groups, hydrogen or hydrogen impurities, without affecting on the mass flow controlling characteristics while the reaction chemical is moving. Thus, the wavelength range of the ultraviolet ray or laser is determined on the consideration of such factors.

As mentioned above, the moisture content in the inert gas such as N₂, He and Ar is kept below 10 ppm owing to the ultraviolet ray or laser.

While the inside of the bubbler system 40 is kept in the inert gas atmosphere, the internal pressure of the bubbler 42 may be changed if external pressure around the bubbler 42 is abnormally great, which thus makes it difficult to control an accurate flow rate of the reaction chemical. Thus, the pressure inside the bubbler cabinet 44 is preferably in the range of 0.5 to 1.5 atm, more preferably not exceeding 10% over the external atmosphere.

In the deposition process in MCVD, the present invention may significantly reduce an optical absorption loss due to hydroxyl groups since the penetration of moisture or hydrogen components from the external atmosphere to the reaction region is prevented. This may be easily understood from the graph shown in FIG. 6.

If an optical fiber is manufactured by simply adding a dehydration process in MCVD, the standard deviation of the optical absorption loss due to hydroxyl groups at 1385 nm is shown to be 0.011 dB/km, which is so great. However, in case of an optical fiber manufactured using the MCVD device of the present invention, the standard deviation of the optical absorption loss due to hydroxyl groups is greatly decreased up to 66%, and the average loss at 1385 nm is also decreased. Thus, it may be understood that removing influence caused by the penetrated moisture or hydrogen components is very important in the optical fiber preform manufacturing procedure in the aspect of productivity of OH-free optical fibers.

When the improvements of the MCVD device according to the present invention is applied to a general single-mode optical fiber manufacture, the single-mode optical fiber shows actual data as shown in the following table 1. Seeing the table 1, it will be known that about 16% loss reduction is shown at 1385 nm on the average, and the standard deviation is also reduced.

TABLE 1

| | | | Present |
|---|---|---|---|
| | | Prior Art | Invention |
| Single-mode | Average Loss@1383 nm | 0.490 dB/km | 0.411 dB/km |
| Optical | Standard | 0.051 dB/km | 0.013 dB/km |
| Fiber | Deviation@1383 nm | | |
| | Average Loss @1310 nm | 0.333 dB/km | 0.331 dB/km |
| | Standard | 0.001 dB/km | 0.001 dB/km |
| | Deviation @1310 nm | | |
| OH-free | Average Loss @1383 nm | 0.320 dB/km | 0.310 dB/km |
| Optical | Standard | 0.011 dB/km | 0.004 dB/km |
| Fiber | Deviation @1383 nm | | |
| | Average Loss @1310 nm | 0.340 dB/km | 0.337 dB/km |
| | Standard | 0.002 dB/km | 0.001 dB/km |
| | Deviation @1310 nm | | |

### INDUSTRIAL APPLICABILITY

The MCVD device for manufacturing an optical fiber preform according to the present invention has advantages of controlling penetration of moisture or hydrogen components into a reaction region and thereby significantly reducing an optical absorption loss due to hydroxyl groups since the inside of the bubbler cabinet is kept in a nitrogen atmosphere.

In addition, the present invention is capable of fundamentally preventing penetration of moisture or hydrogen components by sealing the junctions of the rotary connector by the sealing chamber so that the sealed area is kept in a nitrogen atmosphere, and also making the inside of the bubbler system be in a nitrogen atmosphere.

Furthermore, it is possible to control a hydrogen content in the nitrogen gas to a suitable level by installing the gas purifier to nitrogen input portions of each region.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. A modified chemical vapor deposition (MCVD) device for manufacturing an optical fiber preform, comprising:
a quartz tube;
a lathe for supporting the quartz tube so that the quartz is rotatable on a central axis thereof;
a bubbler system for generating reaction gas to be supplied into the quartz tube;
a rotary connector for interfacing a main headstock of the lathe with the bubbler system; and
a sealing chamber surrounding an area including the rotary connector in order to isolate the area including the rotary connector from the external atmosphere,
wherein the sealing chamber includes an input pipe for flowing inert gas therein and an output pipe for discharging the inert gas,
whereby the inside of the sealing chamber is kept in an inert gas atmosphere.

2. An MCVD device according to claim 1, further comprising a cabinet for isolating an area including at least the quartz tube and its junctions from the external atmosphere and keeping the isolated area in an inert gas atmosphere.

3. An MCVD device according to claim 2, wherein the cabinet includes:
a gas torch installed at a lower end of the cabinet for supplying inert gas into the isolated area; and
a discharge hole for discharging the inert gas from the gas torch and a heated air near the quartz tube to outside.

4. An MCVD device according to claim 3,
wherein a gas purifier is connected to the gas torch in order to control a moisture content of the inert gas.

5. An MCVD device according to claim 4,
wherein a moisture content of the insert gas is less than 100 ppm.

6. An MCVD device according to any of claims 1 to 3,
wherein the inert gas is at least one selected from the group consisting of N₂, He and Ar.

7. An MCVD device according to any of claims 1 to 3, further comprising a pressure control means installed to the input pipe for controlling internal pressure of the sealing chamber.

8. An MCVD device according to claim 7,
wherein the internal pressure of the sealing chamber is kept in the range of 0.5 to 1.5 atm.

9. An MCVD device according to any of claims 1 to 3,
wherein a gas purifier is connected to the input pipe in order to control a moisture content of the inert gas.

10. An MCVD device according to claim 9,
wherein a moisture content of the inert gas is less than 10 ppm.

11. An MCVD device according to any of claims 1 to 3, further comprising a pressure gauge for measuring internal pressure of the sealing chamber.

12. An MCVD device according to any of claims 1 to 3, wherein the bubbler system includes:
at least one bubbler for generating reaction gas to be supplied to the quartz tube;
a mass flow controller for controlling a flow rate of the reaction gas supplied from the bubbler; and
a bubbler cabinet for isolating the bubbler and the mass flow controller from the external atmosphere, and keeping the isolated area in an inert gas atmosphere.

13. An MCVD device according to claim 12,
wherein an ultraviolet generator is installed in the bubbler cabinet to emit ultraviolet rays having a wavelength of 400 nm or below.

14. An MCVD device according to claim 12,
wherein a laser generator is installed in the bubbler cabinet to emit laser having a wavelength of 400 nm or below.

15. An MCVD device according to claim 12, wherein the bubbler cabinet is provided with:
a gas torch for supplying inert gas into the isolated area; and
a gas discharge hole for discharging the inert gas out of the bubbler cabinet.

16. An MCVD device according to claim 15,
wherein an internal pressure of the bubbler cabinet is kept in the range of 0.5 to 1.5 atm.

17. An MCVD device according to claim 15,
wherein a gas purifier is connected to the gas torch in order to control a moisture content of the inert gas.

18. An MCVD device according to claim 15,
wherein a moisture content of the inert gas is less than 10 ppm.

19. An MCVD device according to claim 15,
wherein the inert gas is at least one selected from the group consisting of N₂, He and Ar.
